(19) United States
(12) Patent Application Publication
(10) Pub. No.: US 2025/0142260 A1
(43) Pub. Date: May 1, 2025

(54) SPEAKER DEVICE

(71) Applicant: MERRY ELECTRONICS (SUZHOU) CO., LTD., Jiangsu Province (CN)

(72) Inventors: LiGuo RAO, Jiangsu Province (CN); ChunLong ZHENG, Jiangsu Province (CN)

(73) Assignee: MERRY ELECTRONICS (SUZHOU) CO., LTD., Jiangsu Province (CN)

(21) Appl. No.: 18/909,573

(22) Filed: Oct. 8, 2024

(30) Foreign Application Priority Data
Oct. 30, 2023 (CN) 202311422120.6

(51) Int. Cl. H04R 9/02; H04R 7/18; H04R 9/04

(52) U.S. Cl. CPC H04R 9/025; H04R 7/18; H04R 9/045

(57) ABSTRACT

A speaker device comprising a magnetic guiding plate, a magnetic circuit module and a vibration module is disclosed. The magnetic circuit module includes a main magnet and an auxiliary magnet disposed on the magnetic guiding plate, wherein the auxiliary magnet is disposed outside the main magnet. The vibration module includes a bracket, a vibration component and a voice coil, wherein the bracket includes a frame body and multiple hot melting pillars, the frame body is disposed on the auxiliary magnet, each of the multiple hot melting pillars has one end extending downward and passing through the magnetic guiding plate from the frame body and fixed on the magnetic guiding plate, the vibration component is disposed on the frame body, the vibration component is disposed on the magnetic circuit module, and the voice coil is disposed under the vibration component and between the main magnet and the auxiliary magnet.

### CROSS REFERENCE TO RELATED APPLICATION

This application claims the priority benefit of Chinese Patent Application Serial Number 202311422120.6, filed on Oct. 30, 2023, the full disclosure of which is incorporated herein by reference.

### BACKGROUND

### Technical Field

The technical field of this application involves the design of waterproof speaker devices, and especially involves a speaker device.

### Related Art

In the current market, a waterproof speaker used in smartwatches and intelligent wearable devices has independent designs for a sealed waterproof structure and a speaker structure. Because both the sealed waterproof structure and the speaker structure are independent and cannot be combined effectively and appropriately, the overall waterproof performance of the speaker is poor. Because the sealed waterproof structure of the speaker and the speaker structure cannot be combined, the waterproof structure is easily detached from the waterproof speaker and the manufacturing cost of the waterproof speaker is high. Additionally, the magnetic circuit structure and vibration structure within the speaker are only bonded with simple adhesives, resulting in the poor anti-drop effect of the speaker structure. The existing design for the speaker structure related to waterproofing still faces the aforementioned issues that need to be addressed.

### SUMMARY

The embodiments of the present application provide a speaker device, which, after assembly of the magnetic guiding plate, magnetic circuit module and vibration module, directly fixes the structure of the vibration module to the magnetic guiding plate through a hot-melt method to solve the problem of poor overall structural strength and poor drop resistance caused by bonding only a part of the structure of the speaker device with glue.

To address the abovementioned technical issues, the present application is embodied as follows.

A speaker device is provided, including: a magnetic guiding plate, a magnetic circuit module and a vibration module. The magnetic circuit module includes a main magnet and an auxiliary magnet, the main magnet and the auxiliary magnet are disposed on the magnetic guiding plate, and the auxiliary magnet is disposed outside the main magnet. The vibration module includes a bracket, a vibration component and a voice coil; the bracket includes a frame body and a plurality of hot melting pillars; the bracket is disposed on the auxiliary magnet; each of the plurality of hot melting pillars has one end extending downward and passing through the magnetic guiding plate from the frame body and fixed on the magnetic guiding plate; the vibration component is disposed on the frame body and the magnetic circuit module; and the voice coil is disposed under the vibration component and between the main magnet and the auxiliary magnet.

In one embodiment, the magnetic guiding plate has a plurality of plate notches, and one end of each hot melting pillar passes through a plate notch.

In one embodiment, the magnetic guiding plate has a plurality of connecting troughs, each of the plurality of connecting troughs has a notch and a trough bottom, the notch of the connecting trough is far away from one side of the magnetic circuit module, the trough bottom of the connecting trough has a plate notch, and one end of the hot melting pillar has a hot melt end part hot melted and fixed in the connecting trough.

In one embodiment, the magnetic circuit module further includes a main magnetic guiding component and an auxiliary magnetic guiding component, the main magnetic guiding component is disposed on the main magnet, and the auxiliary magnetic guiding component is disposed on the auxiliary magnet.

In one embodiment, the auxiliary magnetic guiding component has an outer side with a plurality of side notches, and one end of the hot melting pillar passes through the side notch.

In one embodiment, the auxiliary magnetic guiding component has an inner magnetic guiding part and an outer magnetic guiding part, the outer magnetic guiding part is disposed outside the inner magnetic guiding part, and the height from the top surface of the inner magnetic guiding part to the top surface of the auxiliary magnet is greater than that from the top surface of the outer magnetic guiding part to the top surface of the auxiliary magnet.

In one embodiment, the frame body of the bracket is disposed on the outer magnetic guiding part.

In one embodiment, the auxiliary magnetic has two ends, each with a notch respectively, and one end of the hot melting pillar passes through the notch.

In one embodiment, the vibration component includes a diaphragm and an elastic support component, the diaphragm has a periphery, the elastic support component supports the periphery of the diaphragm, and the elastic support component is disposed on the bracket.

In one embodiment, the bracket has an inner sidewall, an outer sidewall and a plurality of fixing holes penetrating the inner sidewall and the outer sidewall; the elastic support component has a connection part, an elastic part and a fixing part which are integrally formed; each of the connection part and the elastic part has an inner side and an outer side respectively; the inner side of the connection part is connected to and fixed to the diaphragm; the outer side of the connection part is connected to the inner side of the elastic part; the outer side of the elastic part is connected to the inner sidewall of the frame body and the fixing part; and the fixing part is formed on the inner sidewall, the outer sidewall and the plurality of fixing holes.

In one embodiment, the fixing part includes an inner fixing part and an outer fixing part which are connected to each other by the plurality of fixing holes; the inner fixing part is fixed on the inner sidewall, and the outer fixing part is fixed on the outer sidewall.

In one embodiment, the outer fixing part of the fixing part has a protrusion part disposed far away from the inner fixing part.

In one embodiment, the outer sidewall has an outer trough connected to the plurality of fixing holes mutually, and the outer fixing part fills the outer trough and the plurality of fixing holes.

In one embodiment, the outer sidewall further includes an outer fixing trough positioned in the outer trough, the outer fixing trough and the outer trough are connected to each other, and the outer fixing part further fills the outer fixing trough.

In one embodiment, the inner sidewall has an inner trough connected to the plurality of fixing holes mutually, and the inner fixing part fills the inner trough and the plurality of fixing holes.

In one embodiment, the outer side of the elastic part is divided into a first elastic connection side and a second elastic connection side, the first elastic connection side extends and overlays onto a trough wall of the inner trough, the first elastic connection side is connected to the inner fixing part, and the second elastic connection side extends toward and overlays onto a sidewall above an opening of the inner trough.

In one embodiment, the inner side of the connection part wraps around a periphery of the diaphragm.

In one embodiment, the voice coil is connected and fixed to the connection part.

In one embodiment, a support component is further included, wherein the bracket has an inner side and there is a connection position between the inner side of the bracket and the elastic part, and the support component is disposed on the connection position between the inner side of the bracket and the elastic part.

The present application provides a speaker device in which the magnetic circuit module is disposed between the magnetic guiding plate and the vibration module; after one end of the hot melting pillar of the vibration module is passed through the magnetic guiding plate, the passed end of the hot melting pillar is directly hot-melted and fixed on the bottom of the magnetic guiding plate to firmly fix the outer structure of the speaker device together such that the structural strength of the overall speaker device can be enhanced to increase the drop resistance.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows in conjunction with the accompanying drawings, of which:

FIG. 1 is a perspective view of the speaker device of the present application;

FIG. 2 is another perspective view of the speaker device of the present application;

FIG. 3 is an exploded view of the speaker device of the present application;

FIG. 4 is another exploded view of the speaker device of the present application;

FIG. 5 is another perspective view of the speaker device of the present application;

FIG. 6 is a cross-sectional view along line A-A′ in FIG. 5;

FIG. 7 is an enlarged view of area B of FIG. 6.

The illustrations are provided in conjunction with the accompanying drawings: 1: speaker device; 11: magnetic guiding plate; 111: plate notch; 112: connecting trough; 113: groove; 13: magnetic circuit module; 131: main magnet; 132: auxiliary magnet; 1321: notch; 133: main magnetic guiding component; 134: auxiliary magnetic guiding component; 1340: side notch; 1341: inner magnetic guiding part; 1342: outer magnetic guiding part; 1343: circuit notch; 15: vibration module; 151: bracket; 1510: fixing notch; 1511: frame body; 15111: inner sidewall; 15112: outer sidewall; 15113: fixing hole; 15114: outer trough; 15115: outer fixing trough; 15116: inner trough; 1512: hot melting pillar; 15121: hot melt end part; 152: vibration component; 1521: diaphragm; 1522: elastic support component; 15221: connection part; 15222: elastic part; 152221: first elastic connection side; 152222: second elastic connection side; 15223: fixing part; 15224: inner fixing part; 15225: outer fixing part; 15226: protrusion part; 152261: convex surface; 152262: first inclined surface; 152263: second inclined surface; 153: voice coil; 17: support ring; 19: conductive component; 191: conductive part; 192: conductive circuit.

### DETAILED DESCRIPTION OF THE EMBODIMENTS

The present invention will now be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that the description of this present invention will be thorough and complete and will fully convey the scope of the present invention to those skilled in the art.

Certain terms are used throughout the description and following claims to refer to particular components. As one skilled in the art will appreciate, manufacturers may refer to a component by different names. This document does not intend to distinguish between components that differ in name but not in function. In the following description and in the claims, the terms “include/including” and “comprise/comprising” are used in an open-ended fashion, and thus should be interpreted as “including but not limited to”. “Substantial/substantially” means within an acceptable error range within which a person skilled in the art may solve the technical problem to achieve the basic technical effect.

The following description is of the best-contemplated mode of carrying out the invention. This description is provided for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that comprises a series of elements includes not only these elements but also other elements not specified expressly, or may include inherent elements of the process, method, object, or device. If no more limitations are made, an element limited by “include a/an . . . ” does not exclude other same elements existing in the process, the method, the article, or the device which comprises the element.

In the following embodiment, the same reference numerals are used to refer to the same or similar elements throughout the invention.

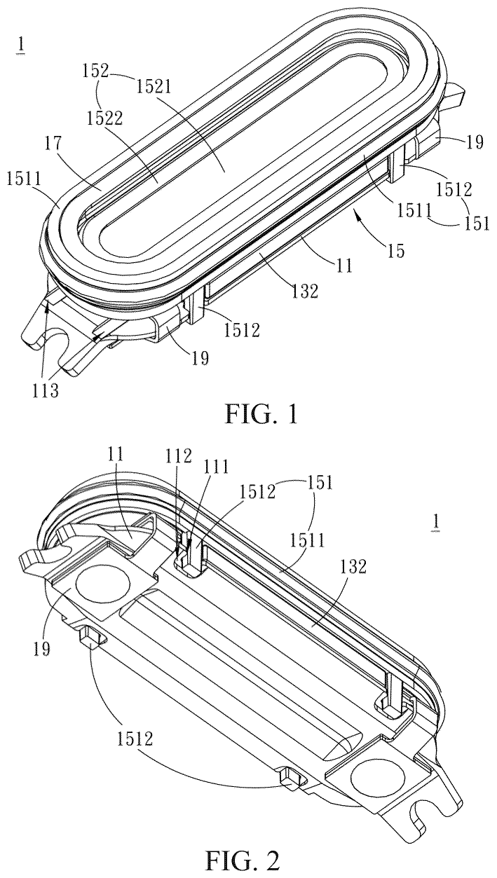

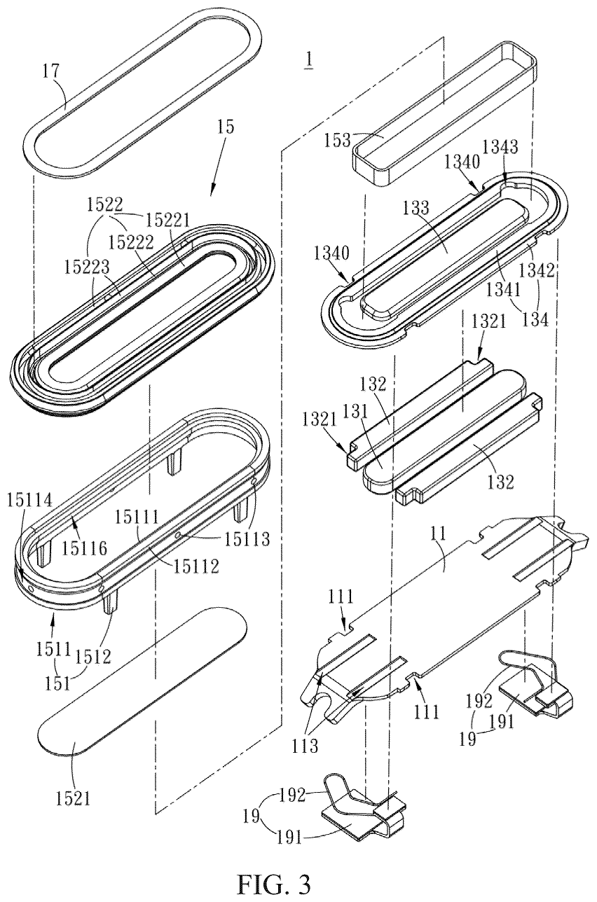

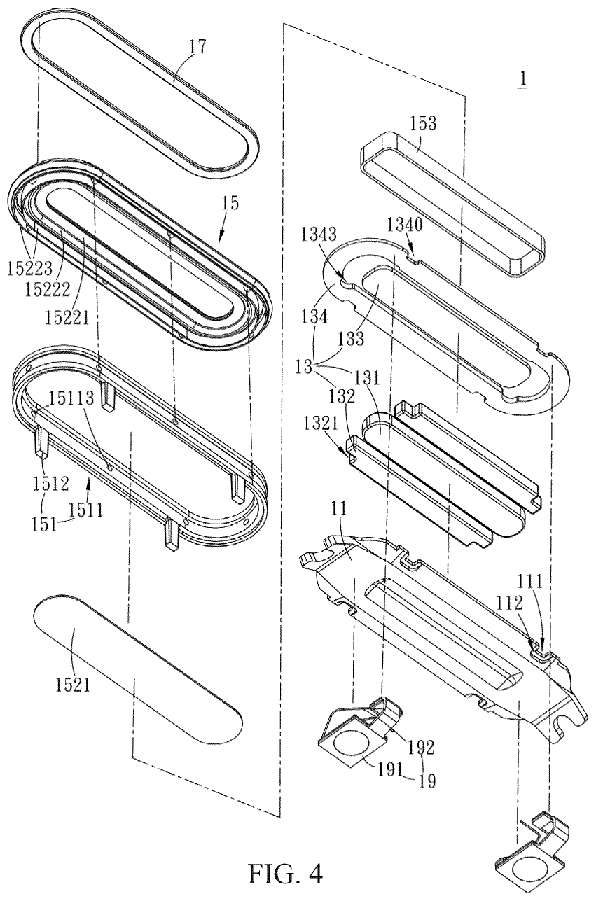

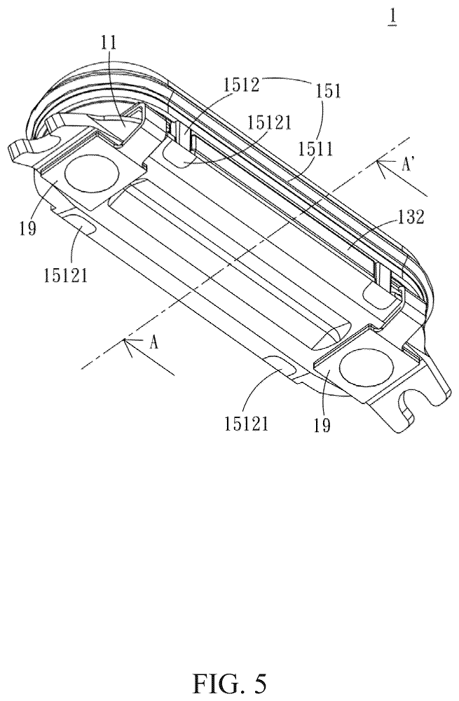

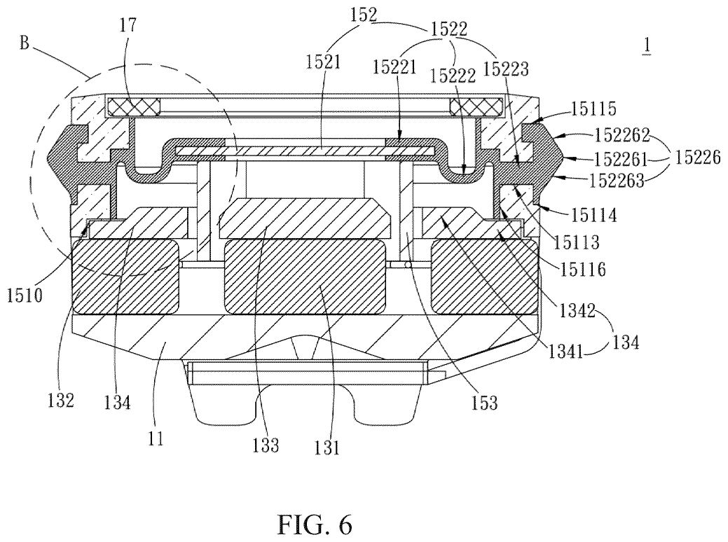

Please refer to FIG. 1 to FIG. 6, wherein FIG. 1 is a perspective view of the speaker device; FIG. 2 is another perspective view; FIG. 3 is an exploded view; FIG. 4 is another exploded view; FIG. 5 is another perspective view; and FIG. 6 is a cross-sectional view along line A-A′ in FIG. 5. As shown in the figures, the present application provides a speaker device 1, including: a magnetic guiding plate 11, a magnetic circuit module 13 and a vibration module 15. The magnetic circuit module 13 includes a main magnet 131 and an auxiliary magnet 132, the main magnet 131 and the auxiliary magnet 132 are disposed on the magnetic guiding plate 11, and the auxiliary magnet 132 is disposed on the outer side of the main magnet 131. The vibration module 15 includes a bracket 151, a vibration component 152 and a voice coil 153. The bracket 151 includes a frame body 1511 and a hot melting pillar 1512, the frame body 1511 is disposed on the auxiliary magnet 132, and one end of the hot melting pillar 1512 extends downward from the frame body 1511 to pass through the magnetic guiding plate 11 and is melted and fixed on the magnetic guiding plate 11. The vibration component 152 is disposed on the frame body 1511 and is located on the magnetic circuit module 13, and the voice coil 153 is disposed under the vibration component 152 and is located between the main magnet 131 and the auxiliary magnet 132.

In this embodiment, there are four hot melting pillars 1512 respectively corresponding to the locations adjacent to the four corners of the frame body 1511, the magnetic guiding plate 11 has a plurality of plate notches 111, each of the plate notches 111 is corresponding to one hot melting pillar 1512, and one end of the hot melting pillar 1512 passes through the corresponding plate notch 111 such that the frame body 1511 of the bracket 151 of the vibration module 15 is stably positioned on the location of the magnetic guiding plate 11 (as shown in FIG. 2). Furthermore, the magnetic guiding plate 11 has a plurality of connecting troughs 112, and the notch of the connecting trough 112 is far away from the magnetic circuit module 13; in other words, the connecting trough 112 is located on the bottom of the magnetic guiding plate 11. The trough bottom of the connecting trough 112 has a plate notch 111, and one end of the hot melting pillar 1512 has a hot melt end part 15121 melted and fixed in the connecting trough 112 such that the hot melt end part 15121 of the hot melting pillar 1512 deforms and the connecting trough 112 is filled with the hot melt end part 15121 of the hot melting pillar 1512, and the hot melt end part 15121 and the bottom of the magnetic guiding plate 11 form a flat-bottomed structure (as shown in FIG. 5). Therefore, the bracket 151 on the outer side of the entire structure of the speaker device 1 is effectively and stably fixed on the magnetic guiding plate 11 of the bottom of the entire structure of the speaker device 1. After the magnetic circuit module 13 is disposed between the magnetic guiding plate 11 and the vibration module 15, the bracket 151 of the vibration module 15 is hot melted and fixed on the magnetic guiding plate 11, and thus, the entire structural strength of the speaker device 1 may be enhanced and the anti-drop effect of the speaker device 1 may be improved.

In addition, the magnetic guiding plate 11 has a groove 113 disposed on one side of the magnetic guiding plate 11 which has the magnetic circuit module 13, and the groove 113 is disposed between the main magnet 131 and the auxiliary magnet 132. There are four grooves 113 respectively disposed on the two sides of the magnetic guiding plate 11, and each of the four grooves 113 respectively extends outward, and the groove 113 is partially corresponding to the voice coil 153. In this embodiment, the groove 113 can serve as a weight reduction structure to reduce the overall weight of the magnetic guiding plate 11 and prevent the lead of the voice coil 153 connected to the conductive module 19 from colliding with the magnetic guiding plate 11 when the voice coil 153 vibrates to cause the speaker device 1 to produce sound.

In this embodiment, the magnetic circuit module 13 further includes a main magnetic guiding component 133 and an auxiliary magnetic guiding component 134. The main magnetic guiding component 133 is disposed on the main magnet 131, and the auxiliary magnetic guiding component 134 is disposed on the auxiliary magnet 132. The main magnetic guiding component 133 and the auxiliary magnetic guiding component 134 are used to concentrate the magnetic lines of the main magnet 131 and the auxiliary magnet 132 to enhance the strength of the magnetic field of the main magnet 131 and the auxiliary magnet 132. Furthermore, the main magnetic guiding component 133 is a long plate structure corresponding to the rectangular structure of the main magnet 131, and the main magnetic guiding component 133 serves as an assistant structure for the main magnet 131 to strengthen the magnetic field. Furthermore, the circular structure of the auxiliary magnetic guiding component 134 corresponds to that of the bracket 151 of the vibration module 15, and the auxiliary magnetic guiding component 134 serves as an auxiliary support structure of the vibration module 15 in addition to serving as an assistant structure for the auxiliary magnet 132 to strengthen the magnetic field.

Furthermore, the outer side of the auxiliary magnetic guiding component 134 has a plurality of side notches 1340, and the number of the side notches 1340 corresponds to the number of the hot melting pillars 1512. One end of the hot melt end part 15121 of each hot melting pillar 1512 passes through the corresponding side notch 1340 such that the hot melting pillar 1512 and the auxiliary magnetic guiding component 134 are further assembled and fitted to reinforce the structural combination strength of the vibration module 15 and the magnetic circuit module 13. In addition, the two ends of the auxiliary magnet 132 have notches 1321 respectively, and one end of the hot melt end part 15121 of each hot melting pillar 1512 passes through the corresponding notch 1321, wherein the notch 1321 of the auxiliary magnet 132 corresponds to the side notch 1340 of the auxiliary magnetic guiding component 134. Thus, the hot melting pillar 1512 and the auxiliary magnet 132 are further assembled and fitted to reinforce the structural combination strength of the vibration module 15 and the magnetic circuit module 13, while simultaneously, the auxiliary magnet 132 is fixed between the two hot melting pillars 1512.

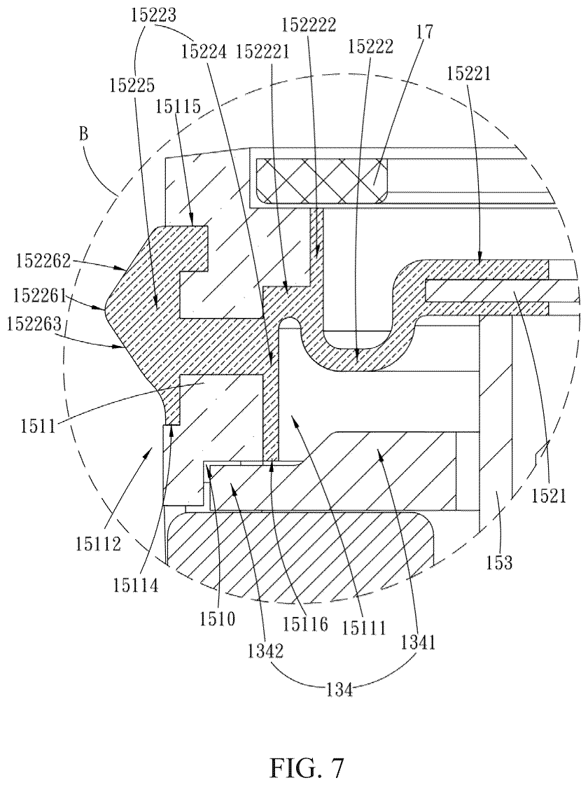

Please refer to FIG. 7, which is an enlarged view of area B of FIG. 6. In this embodiment, the auxiliary magnetic guiding component 134 includes an inner magnetic guiding part 1341 and an outer magnetic guiding part 1342; the outer magnetic guiding part 1342 is disposed on the outer side of the inner magnetic guiding part 1341, and the height from the top surface of the inner magnetic guiding part 1341 to the top surface of the auxiliary magnet 132 is greater than that from the top surface of the outer magnetic guiding part 1342 to the top surface of the auxiliary magnet 132. In other words, the height of the auxiliary magnetic guiding component 134 relative to one side of the vibration module 15 is such that the internal height is greater than the external height. In addition, the frame body 1511 of the bracket 151 is disposed on the outer magnetic guiding part 1342, the bottom of the bracket 151 has a fixing notch 1510, and the outer magnetic guiding part 1342 is fixed in the fixing notch 1510. Thus, the frame body 1511 of the bracket 151 and the outer magnetic guiding part 1342 of the auxiliary magnetic guiding component 134 can be combined and fixed stably.

Please refer to FIG. 6 and FIG. 7 again. FIG. 6 is a cross-sectional view of the line A-A′ in FIG. 5, and FIG. 7 is an enlarged view of area B of FIG. 6. As shown in the figures, the vibration component 152 includes a diaphragm 1521 and an elastic support component 1522; the elastic support component 1522 supports the periphery of the diaphragm 1521, and the elastic support component 1522 is disposed on the bracket 151. The diaphragm 1521 primarily serves as the vibrating membrane structure in the sound-emitting area of the speaker device 1, the sound is primarily emitted through the diaphragm 1521, and the elastic support component 1522 primarily forms the edge structure for the sound-emitting area of the speaker device 1, providing an elastic space for the vertical vibration of the diaphragm 1521.

Furthermore, in this embodiment, the elastic support component 1522 includes a connection part 15221, an elastic part 15222 and a fixing part 15223 which are integrally formed. When the speaker device 1 is immersed in water, the elastic part 15222 of the elastic support component 1522 suffers compression caused by hydraulic pressure toward the interior of the speaker device 1. The compression causes the elastic support component 1522 to be recessed toward the inner magnetic guiding part 1341 of the auxiliary magnetic guiding component 134. The inner magnetic guiding part 1341 is designed as a platform which protrudes toward the elastic support component 1522 of the vibration component 152, and the elastic part 15222 of the elastic support component 1522 receives structural support from the inner magnetic guiding part 1341. Hence, the impact of the elastic part 15222 of the elastic support component 1522 caused by the compression due to hydraulic pressure will be reduced and the risk of cracking the elastic part 15222 of the elastic support component 1522 and so forth due to excessive hydraulic pressure will also be reduced.

In this embodiment, the elastic support component 1522 of the vibration component 152 is produced on the frame body 1511 of the bracket 151 by injection molding. The frame body 1511 of the bracket 151 has an inner sidewall 15111, an outer sidewall 15112 and a plurality of fixing holes 15113 penetrating the inner sidewall 15111 and the outer sidewall 15112. The elastic support component 1522 includes the connection part 15221, the elastic part 15222 and the fixing part 15223; the connection part 15221, elastic part 15222 and fixing part 15223 of the elastic support component 1522 are integrally formed; the inner side of the connection part 15221 is connected to and fixed to the diaphragm 1521; the outer side of the connection part 15221 is connected to the inner side of the elastic part 15222; the outer side of the elastic part 15222 is connected to the inner sidewall 15111 of the frame body 1511 and the fixing part 15223; and the fixing part 15223 is formed on the inner sidewall 15111, outer sidewall 15112 and the plurality of the fixing holes 15113; wherein the fixing part 15223 is made of silicone sealants, the connection part 15221 and the elastic part 15222 are made of silicone membranes, and the fixing part 15223, the connection part 15221 and the elastic part 15222 are integrally formed. The elastic support component 1522 in this embodiment is fixed on the frame body 1511 by integral formation to enhance the anti-drop effect of the speaker device 1.

As described above, the fixing part 15223 includes an inner fixing part 15224 and an outer fixing part 15225, the inner fixing part 15224 and the outer fixing part 15225 are connected with each other through the plurality of fixing holes 15113, the inner fixing part 15224 is fixed on the inner sidewall 15111, and the outer fixing part 15225 is fixed on the outer sidewall 15112. The outer fixing part 15225 of the fixing part 15223 has a protrusion part 15226 positioned on one side far away from the inner fixing part 15224. In other words, the protrusion part 15226 of the outer fixing part 15225 corresponds to the outer side of the speaker device 1. Furthermore, the protrusion part 15226 has a convex surface 152261, a first inclined surface 152262 and a second inclined surface 152263; the first inclined surface 152262 and second inclined surface 152263 are disposed at both sides of the convex surface 152261, and the first inclined surface 152262 and the second inclined surface 152263 are symmetrically arranged based on the convex surface 152261. When the speaker device 1 is submerged in water, the convex surface 152261, first inclined surface 152262, and second inclined surface 152263 can disperse the pressure caused by the compression of the external hydraulic pressure on the interior of the speaker device 1, causing the external pressure based on the convex surface 152261 to be dispersed to the first inclined surface 152262 and second inclined surface 152263. Thus, the pressure on the outer fixing part 15225 is distributed, and furthermore, the interior pressure of the speaker device 1 caused by the hydraulic pressure is relieved.

In addition, the outer sidewall 15112 of the frame body 1511 of the bracket 151 has an outer trough 15114 connected to the plurality of fixing holes 15113 mutually, and the outer trough 15114 and the plurality of fixing holes 151113 are filled with the outer fixing part 15225. Furthermore, the outer sidewall 15112 has an outer fixing trough 15115 positioned in the outer trough 15114, the outer fixing trough 15115 and the outer trough 15114 are connected to each other, and furthermore, the outer fixing trough 15115 is filled by the outer fixing part 15225. The outer fixing trough 15115 in this embodiment can be positioned in the upper position or/and lower position relative to the plurality of fixing holes 15113, and the position of the outer fixing trough 15115 can be adjusted according to the users' need. Through the outer trough 15114 and outer fixing trough 15115, the contact area of the outer sidewall 15112 relative to the outer fixing part 15225 is increased. Hence, the structural bonding strength of the outer fixing part 15225 formed on the outer sidewall 15112 is enhanced, and the frame body 1511 and the fixing part 15223 of the elastic support component 1522 constitute a non-planar structure, which is beneficial to prevent water from entering the interior of the speaker device 1. In addition, the inner sidewall 15111 of the frame body 1511 of the bracket 151 has an inner trough 15116 connected to the plurality of fixing holes 15113 mutually, and the inner trough 15116 and the plurality of fixing holes 15113 are filled with the inner fixing part 15224.

In this embodiment, the elastic part 15222 serves as a connecting structure to connect the fixing part 15223 and the connection part 15221. The elastic part 15222 has the greatest tensile toughness and provides a structure for the connection part 15221, diaphragm 1521 and voice coil 153 to vibrate, and the elastic part 15222 also serves as a structure for limiting vibration amplitude. The outer side of the elastic part 15222 is divided into a first elastic connection side 152221 and a second elastic connection side 152222. The first elastic connection side 152221 extends and is attached to the trough wall of the inner trough 15116, the first elastic connection side 152221 is connected to the inner fixing part 15224, and the second elastic connection side 152222 extends and is attached to the sidewall above the opening of the inner trough 15116. Hence, an L-shaped structure is attached to the inner sidewall 15111 of the frame body 1511 to enhance the outer side connecting strength of the elastic part 15222.

In addition, the inner side of the connection part 15221 of the elastic support component 1522 wraps around the periphery of the diaphragm 1521, as shown in FIG. 6 and FIG. 7. In other words, the connection part 15221 extends onto the top surface and the bottom surface of the diaphragm 1521 such that the connection part 15221 is stably connected to the diaphragm 1521. Afterward, the voice coil 153 is fixed on the connection part 15221 so that when the voice coil 153 is vibrated by the interaction of the magnetic field of the magnetic circuit module 13, the voice coil 153 will directly act on the connection part 15221 of the elastic support component 1522. Because the elastic support component 1522 can directly bear higher vibration strength compared to the diaphragm 1521, it increases the fixing strength of the voice coil 153. In addition, it can be seen in the figures that the inner side of the connection part 15221 wraps around the top side and the bottom side on the periphery of the diaphragm 1521 and extends toward the center of the diaphragm 1521, which improves the waterproofing effect.

Please refer to FIG. 7 again. The speaker device 1 further includes a support ring 17 disposed on the connection position between the inner side of the bracket 151 and the elastic part 15222. Furthermore, the second elastic connection side 152222 extends to the sidewall above the opening of the inner trough 15116 to attach to the connection position of the elastic part 15222. In other words, the support ring 17 is disposed on the connection position between the second elastic connection side 152222 and the inner side of the bracket 151. The support ring 17 in this embodiment can be a support structure for a dust-proof net (not shown), and the dust-proof net is used to prevent dust from invading the diaphragm 1521 and elastic support component 1522.

Please refer to FIG. 3 to FIG. 5. The speaker device 1 further includes a conductive component 19, and the conductive component 19 includes a conductive part 191 and a conductive circuit 192. The conductive part 191 is fixed on the bottom of the magnetic guiding plate 11, one end of the conductive part 191 extends to and is fixed on the auxiliary magnetic guiding component 134, one end of the conductive circuit 192 is connected to one end of the conductive part 191, and the other end of the conductive circuit 192 is connected to the voice coil 153. In this embodiment, due to the connection of the conductive part 191 on the bottom of the magnetic guiding plate 11 to external power (not shown), the conductive part 191 transmits power to the voice coil 153 through the conductive circuit 192. Furthermore, the inner side of the auxiliary magnetic guiding component 134 has a circuit notch 1343, and one end of the conductive circuit 192 passes through the circuit notch 1343 to connect to the voice coil 153. This is advantageous for the conductive circuit 192 to connect to the voice coil 153 through the auxiliary magnetic guiding component 134. Thus, the situation wherein the vibration of the voice coil 153 causes the conductive circuit 192 to vibrate can be prevented, the circuit notch 1343 can reduce the interference of the auxiliary magnetic guiding component 134 on the vibration of the conductive circuit 192, and further, the situation wherein the conductive circuit 192 influences the vibration of the voice coil 153 in reverse is prevented. In this embodiment, when the voice coil 153 receives the input power to change the magnetic field, the voice coil 153 and the magnetic circuit module 13 interact mutually to make the voice coil 153 generate vibrations; the voice coil 153 further drives the diaphragm 1521 of the vibration component 152 and the elastic support component 1522 to vibrate, and the diaphragm 1521 produces sound via the vibration. In summary, the present application provides a speaker device wherein the elastic support component of the vibration component is formed on the inner sidewall, the outer sidewall and the plurality of fixing holes of the bracket by integral injection molding such that the elastic support component can be firmly combined with the bracket, thereby improving the bonding strength between the vibration component and the bracket, and a complete seal of the vibration component and the bracket can be realized so as to achieve an effective waterproofing effect.

In summary, the present application provides a speaker device in which the magnetic circuit module is disposed between the magnetic guiding plate and the vibration module; after the positioning of one end of the hot melting pillar of the vibration module through the magnetic guiding plate, the passed end of the hot melting pillar is directly hot-melted and fixed on the bottom of the magnetic guiding plate to firmly fix the outer structure of the speaker device together such that the structural strength of the overall speaker device can be enhanced to increase the drop resistance.

It is to be understood that the term “comprises”, “comprising”, or any other variants thereof is intended to encompass a non-exclusive inclusion, such that a process, method, article, or device of a series of elements not only includes those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, the description herein does not intend to limit the present invention. It will be apparent to those skilled in the art with regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. A speaker device, comprising:
a magnetic guiding plate;
a magnetic circuit module, comprising a main magnet and an auxiliary magnet, wherein the main magnet and the auxiliary magnet are disposed on the magnetic guiding plate, and the auxiliary magnet is disposed on an outer side of the main magnet; and
a vibration module, comprising a bracket, a vibration component and a voice coil, wherein the bracket comprises a frame body and a plurality of hot melting pillars, the bracket is disposed on the auxiliary magnet, each of the plurality of hot melting pillars has one end extending downward and passing through the magnetic guiding plate from the frame body and fixed on the magnetic guiding plate, the vibration component is disposed on the frame body and is located on the magnetic circuit module, and the voice coil is disposed under the vibration component and is located between the main magnet and the auxiliary magnet.

2. The speaker device as claimed in claim 1, wherein the magnetic guiding plate has a plurality of plate notches, and one end of each hot melting pillar passes through the plate notch.

3. The speaker device as claimed in claim 2, wherein the magnetic guiding plate has a plurality of connecting troughs, each of the plurality of connecting troughs has a notch and a trough bottom, the notch of the connecting trough is far away from one side of the magnetic circuit module, the trough bottom of the connecting trough has the plate notch, and one end of the hot melting pillar has a hot melt end part hot melted and fixed in the connecting trough.

4. The speaker device as claimed in claim 1, wherein the magnetic circuit module further comprises a main magnetic guiding component and an auxiliary magnetic guiding component, the main magnetic guiding component is disposed on the main magnet, and the auxiliary magnetic guiding component is disposed on the auxiliary magnet.

5. The speaker device as claimed in claim 4, wherein the auxiliary magnetic guiding component has an outer side with a plurality of side notches, and one end of the hot melting pillar passes through the side notch.

6. The speaker device as claimed in claim 4, wherein the auxiliary magnetic guiding component has an inner magnetic guiding part and an outer magnetic guiding part, the outer magnetic guiding part is disposed outside the inner magnetic guiding part, and the height from the top surface of the inner magnetic guiding part to the top surface of the auxiliary magnet is greater than that from the top surface of the outer magnetic guiding part to the top surface of the auxiliary magnet.

7. The speaker device as claimed in claim 6, wherein the frame body of the bracket is disposed on the outer magnetic guiding part.

8. The speaker device as claimed in claim 1, wherein the auxiliary magnetic has two ends, each with a notch respectively, and one end of the hot melting pillar passes through the notch.

9. The speaker device as claimed in claim 1, wherein the vibration component comprises a diaphragm and an elastic support component, the diaphragm has a periphery, the elastic support component supports the periphery of the diaphragm, and the elastic support component is disposed on the bracket.

10. The speaker device as claimed in claim 9, wherein the frame body of the bracket has an inner sidewall, an outer sidewall and a plurality of fixing holes penetrating the inner sidewall and the outer sidewall; the elastic support component has a connection part, an elastic part and a fixing part which are integrally formed; each of the connection part and the elastic part has an inner side and an outer side respectively; the inner side of the connection part is connected to and fixed to the diaphragm; the outer side of the connection part is connected to the inner side of the elastic part; the outer side of the elastic part is connected to the inner sidewall of the frame body and the fixing part; and the fixing part is formed on the inner sidewall, the outer sidewall and the plurality of fixing holes.

11. The speaker device as claimed in claim 10, wherein the fixing part comprises an inner fixing part and an outer fixing part which are connected to each other by the plurality of fixing holes, the inner fixing part is fixed on the inner sidewall, and the outer fixing part is fixed on the outer sidewall.

12. The speaker device as claimed in claim 11, wherein the outer fixing part of the fixing part has a protrusion part disposed on one side far away from the inner fixing part.

13. The speaker device as claimed in claim 10, wherein the outer sidewall has an outer trough connected to the plurality of fixing holes mutually, and the outer trough and the plurality of fixing holes are filled by the outer fixing part.

14. The speaker device as claimed in claim 13, wherein the outer sidewall further comprises an outer fixing trough positioned in the outer trough, the outer fixing trough and the outer trough are connected to each other, and the outer fixing trough is further filled with the outer fixing part.

15. The speaker device as claimed in claim 10, wherein the inner sidewall has an inner trough connected to the plurality of fixing holes mutually, and the inner trough and the plurality of fixing holes are filled by the inner fixing part.

16. The speaker device as claimed in claim 15, wherein the outer side of the elastic part is divided into a first elastic connection side and a second elastic connection side, the first elastic connection side extends to and is attached to a trough wall of the inner trough, the first elastic connection side is connected to the inner fixing part, and the second elastic connection side extends toward and is attached to a sidewall above an opening of the inner trough.

17. The speaker device as claimed in claim 10, wherein the inner side of the connection part wraps around a periphery of the diaphragm.

18. The speaker device as claimed in claim 17, wherein the voice coil is connected and fixed to the connection part.

19. The speaker device as claimed in claim 10, further comprising a support component disposed on the connection between the inner side of the bracket and the elastic part.
